(19) United States
(12) Patent Application Publication
(10) Pub. No.: US 2025/0252768 A1
(43) Pub. Date: Aug. 7, 2025

(54) IMAGE READING SYSTEM, IMAGE READING DEVICE, AND CONTROL DEVICE

(71) Applicant: SEIKO EPSON CORPORATION, Tokyo (JP)

(72) Inventor: Daiki SATO, FUKUOKA-SHI (JP)

(21) Appl. No.: 19/040,155

(22) Filed: Jan. 29, 2025

(30) Foreign Application Priority Data
Feb. 1, 2024 (JP) 2024-014290

(51) Int. Cl. G06V 30/413; B65H 5/00; G06F 3/14

(52) U.S. Cl. CPC G06V 30/413; B65H 5/002; G06F 3/14

(57) ABSTRACT

An image reading system is provided with a transport section for transporting sheets of documents one sheet at a time from a document bundle, a reading section for reading the documents, a detection section for detecting the documents, a display section for displaying a setting screen on which a target condition, which is a condition of documents that are the target of reading, is set, and a control section, wherein when the detection section detects a document that does not match the target condition, the control section causes the display section to display that a document that does not match the target condition has been detected.

The present application is based on, and claims priority from JP Application Serial Number 2024-014290, filed Feb. 1, 2024, the disclosure of which is hereby incorporated by reference herein in its entirety.

### BACKGROUND

### 1. Technical Field

The present invention relates to an image reading system, an image reading device, and a control device.

### 2. Related Art

WO2023/067709 describes an image reading device for transporting a document from a set document bundle.

In the image reading device, documents not intended by a user may be mixed in the document bundle. For example, documents of different sizes may be mixed in the document bundle in which documents that are the reading targets are stacked. In this case, the user may not be able to obtain a desired reading result.

### SUMMARY

An image reading system for solving the above problem includes a transport section for transporting sheets of documents one sheet at a time from a document bundle; a reading section for reading a document; a detection section for detecting a document; a display section for displaying a setting screen on which a document condition is set as a target condition of a document that is a reading target; and a control section, wherein when the detection section detects a document that does not meet the target condition, the control section causes the display section to display that a document that does not meet the target condition has been detected.

An image reading device that solves the above problem includes a transport section for transporting sheets of documents one sheet at a time from a document bundle; a reading section for reading a document; a detection section for detecting a document; a display section for displaying a setting screen on which a document condition is set as a target condition of a document that is a reading target; and a control section, wherein when the detection section detects a document that does not meet the target condition, the control section causes the display section to display that a document that does not meet the target condition has been detected.

A control device that solves the above problem is a control device connected to an image reading device, the image reading device including a transport section for transporting sheets of documents one sheet at a time from a document bundle, a reading section for reading a document, and a detection section for detecting a document, the control device including a display section for displaying a setting screen on which a document condition is set as a target condition, which is a condition of a document that is the reading target of the image reading device and a control section configured to communicate with the image reading device, wherein when the detection section detects a document that does not meet the target condition, the control section causes the display section to display that a document that does not meet the target condition has been detected.

A control method that solves the above problem is for an image reading system including a transport section for transporting sheets of documents one sheet at a time from a document bundle, a reading section for reading a document, a detection section for detecting a document, a display section for displaying a setting screen on which a document condition is set as a target condition of a document that is a reading target, the control method including the detection section detecting a document and, when a document that does not meet the target condition was detected, the display section indicating that a document not meeting the target condition was detected.

### BRIEF DESCRIPTION OF THE DRAWINGS

FIG. 1 is a schematic diagram showing an example of an image reading system.

FIG. 2 is a schematic diagram showing the home screen.

FIG. 3 is a schematic diagram showing a selection screen.

FIG. 4 is a schematic diagram showing a count setting screen.

FIG. 5 is a schematic diagram showing a status screen.

FIG. 6 is a schematic diagram showing a count change screen.

FIG. 7 is a graph showing an example of speed change of a pick-up roller.

FIG. 8 is a graph showing an example different from that of FIG. 7 with respect to the speed change of the pick-up roller.

FIG. 9 is a graph showing an example different from those of FIGS. 7 and 8 with respect to the speed change of the pick-up roller.

FIG. 10 is a schematic diagram showing a count continue screen.

FIG. 11 is a schematic diagram showing a count end screen.

FIG. 12 is a schematic diagram showing a count preserve screen.

FIG. 13 is a schematic diagram showing a confirmation setting screen.

FIG. 14 is a schematic diagram showing a confirmation change screen.

FIG. 15 is a schematic diagram showing a confirmation continue screen.

FIG. 16 is a schematic diagram showing a notification screen.

FIG. 17 is a schematic diagram showing a confirmation end screen.

FIG. 18 is a schematic diagram showing a confirmation preserve screen.

FIG. 19 is a flowchart showing operation in a count mode.

FIG. 20 is a flowchart showing operation in a confirmation mode.

### DESCRIPTION OF EMBODIMENT

Hereinafter, an embodiment of an image reading system will be described with reference to the drawings.

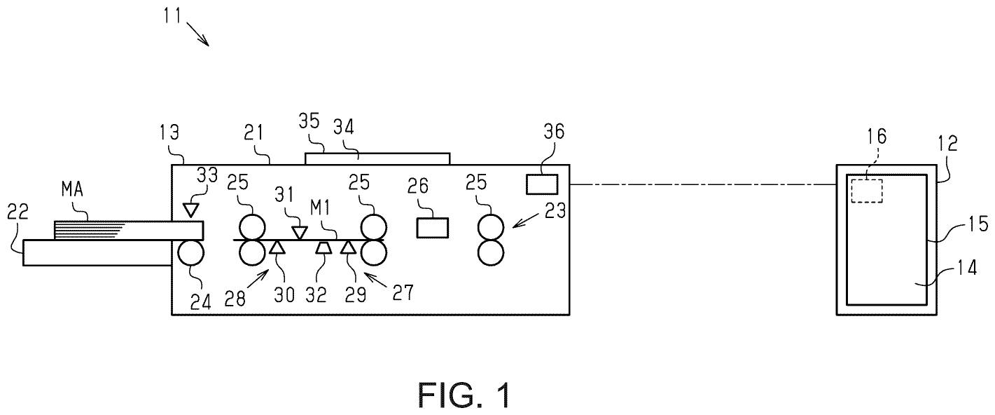

As shown in FIG. 1, the image reading system 11 includes a control device 12 and an image reading device 13. The control device 12 is configured to control the image reading device 13. The control device 12 communicates with the image reading device 13. The control device 12 is connected to the image reading device 13 by wireless or wired means. The control device 12 is, for example, a personal computer, a smartphone, or a tablet. In the image reading system 11, the control device 12 may store a driver for controlling the image reading device 13. In the image reading system 11, the image reading device 13 may operate independently.

### Control Device

The control device 12 is provided with an operation section. More specifically, the control device 12 includes a terminal operation section 14. The terminal operation section 14 is operated by a user. The user operates the control device 12 through the terminal operation section 14. The terminal operation section 14 is, for example, a touch panel. The terminal operation section 14 is not limited to a touch panel, and may be a button, a lever, or the like.

The control device 12 is provided with a display section. More specifically, the control device 12 includes a terminal display section 15. The terminal display section 15 displays a screen. More specifically, the terminal display section 15 displays a screen for operating the image reading device 13. The user gives instructions to the image reading device 13 through the screen displayed on the terminal display section 15.

The control device 12 is provided with a control section. More specifically, the control device 12 includes a terminal control section 16. The terminal control section 16 controls the terminal display section 15. The terminal control section 16 controls the terminal display section 15 to display a screen. The terminal control section 16 is configured to communicate with the image reading device 13. The terminal control section 16 transmits instructions input through the screen displayed on the terminal display section 15 to the image reading device 13.

The terminal control section 16 may be composed of one or more processors that execute various processes according to a computer program. The terminal control section 16 may be composed of one or more dedicated hardware circuits such as an ASIC for executing at least a part of various processes. The terminal control section 16 may be configured by a circuit including a combination of a processor and a hardware circuit. The processor includes a CPU and memory, such as RAM and ROM. The memory stores program code or instructions configured to cause the CPU to perform processes. Memory, that is, computer readable medium, includes any readable medium that can be accessed by a general purpose or special purpose computer.

### Image Reading Device

The image reading device 13 is configured to read a document M1. The image reading device 13 is, for example, a scanner for reading an image such as a character or a photograph printed on the document M1, such as a sheet of paper or film.

The image reading device 13 includes a housing 21.

The image reading device 13 includes a supply tray 22. A document bundle MA in which plural documents M1 are stacked is set on the supply tray 22. The supply tray 22 extends from the housing 21. The supply tray 22 guides the document M1 into the housing 21.

The image reading device 13 includes a transport section 23. The transport section 23 is configured to transport the document M1. The transport section 23 transports sheets of documents M1 one sheet at a time from the document bundle MA. The transport section 23 transports a document M1 on the supply tray 22 into the housing 21. The transport section 23 discharges the document M1 from the inside of the housing 21 to the outside of the housing 21.

The transport section 23 has a plurality of rollers. The transport section 23 has a pick-up roller 24. The pick-up roller 24 is a roller for transporting documents M1 one sheet at a time from the document bundle MA. In one example, the pick-up roller 24 contacts the lowermost document M1 of the document bundle MA. The transport section 23 has one or more transport roller pairs 25. The transport roller pairs 25 rotate while nipping the document M1. The transport section 23 may have a retardation roller for suppressing multi-feed. Multi-feed means that plural sheets of documents M1 are transported stacked on each other. The retardation roller rotates to return the document M1 from the housing 21 to the supply tray 22, for example.

The image reading device 13 includes a reading section 26. The reading section 26 is configured to read the document M1. The reading section 26 reads the transported document M1. The reading section 26 is composed of multiple optical sensors arranged in the main scanning direction. The reading section 26 is, for example, a contact image sensor module. The reading section 26 may be configured to read one side of the document M1 or both sides.

The image reading device 13 includes a detection section 27. The detection section 27 is configured to detect the document M1. The detection section 27 is configured to detect at least one of the size of the document M1 or the type of the document M1. The detection section 27 may be configured to detect the size of the document M1, may be configured to detect the type of the document M1, or may be configured to detect both. In one example, the detection section 27 detects both the size of the document M1 and the type of the document M1.

The detection section 27 includes a size detection section 28. The size detection section 28 is configured to detect the size of the document M1. The size detection section 28 detects the size of the document M1 in the main scanning direction and the size of document M1 in the sub-scanning direction.

The size detection section 28 has a main scanning detection section 29. The main scanning detection section 29 is configured to detect the size of the document M1 in the main scanning direction. In one example, the main scanning detection section 29 is configured by a plurality of optical sensors arranged in the main scanning direction. The size detection section 28 detects the size of the document M1 in the main scanning direction by the main scanning detection section 29 detecting both side edges of the document M1. The main scanning detection section 29 may be configured by the reading section 26.

The size detection section 28 has a sub-scanning detection section 30. The sub-scanning detection section 30 is configured to detect the size of the document M1 in the sub-scanning direction. In one example, the sub-scanning detection section 30 is composed of a single optical sensor. The sub-scanning detection section 30 detects the leading end of the document M1 and the trailing end of the document M1. The size detection section 28 detects the size of document M1 in the sub-scanning direction based on the amount of transport by the transport section 23 from the time when the sub-scanning detection section 30 detects the leading end of document M1 to the time when the sub-scanning detection section 30 detects the trailing end of document M1.

The detection section 27 includes a type detection section 31. The type detection section 31 is configured to detect the type of the document M1. The type detection section 31 is composed of an optical sensor. The type detection section 31 irradiates the document M1 with light and receives the reflected light. The type detection section 31 detects the type of document M1 based on the waveform of the reflected light. For example, when the document M1 is high-quality paper, the waveform of the reflected light is more uniform than when document M1 is a plain paper. When the document M1 is recycled paper, the waveform of the reflected light varies as compared to when the document M1 is plain paper. The type detection section 31 may include an ultrasonic sensor. In this case, the type detection section 31 irradiates ultrasonic waves onto the document M1. The type detection section 31 detects the type of the document M1 based on the attenuation rate of the ultrasonic waves. For example, when the document M1 is thick paper, the attenuation rate of the ultrasonic waves is larger than when the document M1 is plain paper. In this manner, the type detection section 31 can detect types such as high-quality paper, plain paper, recycled paper, and thick paper.

The image reading device 13 includes a multi-feed detection section 32. The multi-feed detection section 32 is configured to detect multi-feed of documents M1. The multi-feed detection section 32 detects whether or not multiple sheets of documents M1 are transported from the supply tray 22 in a stacked state.

The multi-feed detection section 32 has an ultrasonic sensor. The multi-feed detection section 32 irradiates the document M1 with ultrasonic waves. The multi-feed detection section 32 detects a multi-feed based on the attenuation rate of the ultrasonic waves. For example, when a multi-feed occurs, the attenuation rate of the ultrasonic waves becomes larger than that when a multi-feed does not occur. By this, the multi-feed detection section 32 detects a multi-feed. The multi-feed detection section 32 may configure the type detection section 31. The multi-feed detection section 32 can detect a thick paper document M1 using the ultrasonic sensor. For example, when a multi-feed occurs, the attenuation rate of the ultrasonic waves becomes larger than when the document M1 is thick paper.

The image reading device 13 may be provided with a tray detection section 33. The tray detection section 33 is configured to detect the document M1 set on the supply tray 22. The tray detection section 33 detects the presence or absence of a document M1 set on the supply tray 22. In one example, the tray detection section 33 is positioned so as to face the pick-up roller 24. The tray detection section 33 is composed of, for example, an optical sensor.

The image reading device 13 includes an operation section. More specifically, the image reading device 13 includes a reading operation section 34. The reading operation section 34 is operated by a user. The user operates the image reading device 13 through the reading operation section 34. The reading operation section 34 is, for example, a touch panel. The reading operation section 34 is not limited to a touch panel, and may be a button, a lever, or the like.

The image reading device 13 includes a display section. More specifically, the image reading device 13 includes a reading display section 35. The reading display section 35 displays a screen. More specifically, the reading display section 35 displays a screen for operating the image reading device 13. The user gives an instruction to the image reading device 13 through the screen displayed on the reading display section 35.

The image reading device 13 includes a control section. More specifically, the image reading device 13 includes a reading control section 36. The reading control section 36 controls the reading display section 35. The reading control section 36 controls the reading display section 35 to display a screen. The reading control section 36 executes an instruction input through the screen displayed on the reading display section 35. The reading control section 36 may control the image reading device 13 based on an instruction transmitted from the control device 12.

Similarly to the terminal control section 16, the reading control section 36 may be constituted by one or more processors, one or more dedicated hardware circuits, or a circuit including a combination of these.

The user usually sets the document bundle MA, in which the documents M1 to be read are stacked, in the image reading device 13. However, a document M1 that is not a target of reading may be mixed in with the document bundle MA. For example, there is a possibility that an A5-size document M1 or a document M1 made of recycled paper may be mixed into a document bundle MA of stacked A4-size plain paper sheets. In this case, if the image reading device 13 reads the document M1 as it is, there is a possibility that the user cannot obtain a desired reading result. Therefore, the image reading device 13 is configured to be able to confirm whether or not a document M1 not intended by the user is mixed in the document bundle MA.

When the detection section 27 detects a document M1 that is not a reading target, the reading control section 36 causes the display section to display that a document M1 that is not a reading target has been detected. The reading control section 36 may cause the reading display section 35 to display that a document M1 that is not a reading target has been detected, or may cause the terminal display section 15 to display it through the terminal control section 16. By this, the user can recognize that a document M1 that is not a reading target is mixed in the document bundle MA. The user can obtain a document bundle MA containing only documents M1 that are the target of reading by removing the document M1 that is not a reading target from the document bundle MA. The user can obtain the desired reading result by setting that document bundle MA in the image reading device 13.

The reading control section 36 is configured to enable setting of a target condition of the document M1 to be read. The target condition includes at least one of the size of document M1 and the type of document M1. The target condition may include only the size of the document M1, only the type of the document M1, or both. The target condition is set through the screen displayed on the display section. That is, the user sets the target condition through a screen displayed on the reading display section 35 or the terminal display section 15. The screen will be described later. When the reading control section 36 detects that the detection section 27 has detected a document M1 that does not match the target condition that was set through the display section, it displays the detection result on the display section.

The reading control section 36 is configured to be capable of executing a count mode. The count mode is a mode for counting the documents M1 that meet the target condition. In the count mode, the reading control section 36 may count the documents M1 that do not meet the target condition in addition to counting the documents M1 that meet the target condition.

The count mode is executed by the user operating the operation section. The count mode may be executed by the user by operating the reading operation section 34 or by operating the terminal operation section 14. In one example, the count mode is a mode that is not performed during reading by the reading section 26. The count mode may be performed during reading by the reading section 26.

In count mode, the reading control section 36 notifies the user of the number of sheets of documents M1 that match the target condition. For example, the reading control section 36 causes the reading display section 35 or the terminal display section 15 to display the number of sheets of documents M1 that match the target condition. In the count mode, the user can grasp the number of sheets of documents M1 that match the target condition. The user can recognize that documents M1 that do not meet the target condition are included in the document bundle MA by the difference between the number of document M1 sheets that meet the target condition and the number of document M1 sheets set on the supply tray 22. In this regard, displaying on the display section the number of document M1 sheets that match the target condition is equivalent to displaying on the display section that a document M1 was detected that does not match the target condition. In the count mode, the reading control section 36 may cause the display section to display the number of sheets of documents M1 that do not meet the target condition. In this case, the user can intuitively understand that a document M1 that does not meet the target condition has been detected.

The reading control section 36 is configured to be capable of executing a confirmation mode. The confirmation mode is a mode for confirming the presence or absence of a document M1 that does not meet the target condition. That is, the confirmation mode is a mode for checking whether or not a document M1 that is not a reading target is included in the document bundle MA set on the supply tray 22.

The confirmation mode is executed by the user operating the operation section. The confirmation mode may be executed by the user by operating the reading operation section 34 or by operating the terminal operation section 14. In one example, the confirmation mode is a mode that does not accompany reading by reading section 26. The confirmation mode may accompany reading by reading section 26.

When the reading control section 36 in the confirmation mode detects a document M1 that does not meet the target condition, the reading control section 36 notifies the user of the detection. For example, the reading control section 36 causes the reading display section 35 or the terminal display section 15 to display a message notifying that a document M1 that does not match the target condition has been detected. In the confirmation mode, the user can recognize that a document M1 that does not meet the target condition is included in the document bundle MA.

The reading control section 36 may be configured to be capable of executing a total count mode. The total count mode is a mode for counting the documents M1 without reference to the target condition. That is, the total count mode is a mode for counting all of the documents M1.

The total count mode is executed by the user operating the operation section. The total count mode may be executed by the user by operating the reading operation section 34 or by operating the terminal operation section 14. In one example, the total count mode is a mode that does not accompany reading by the reading section 26. The total count mode may accompany reading by reading section 26.

The reading control section 36 notifies the user of the number of sheets of documents M1 counted in the total count mode. For example, the reading control section 36 displays the counted number of sheets of documents M1 on the reading display section 35 or the terminal display section 15. In the total count mode, the user can grasp the number of sheets of the documents M1 constituting the document bundle MA.

The reading control section 36 may be configured to be capable of executing a collation mode. The collation mode is a mode in which documents M1 are counted without reference to the target condition, and then the total number of sheets of documents M1 counted this time is collated with the total number of sheets of documents M1 counted in the total count mode. The collation mode is a mode for confirming whether or not other documents M1 are mixed in with, or documents M1 are missing from, the document bundle MA constituted by the documents M1 that were counted in the total count mode.

The collation mode is executed by the user operating the operation section. The collation mode may be executed by the user operating the reading operation section 34 or operating the terminal operation section 14. In one example, the collation mode is a mode that does not accompany reading by the reading section 26. The collation mode may accompany reading by reading section 26.

The collation mode can be executed after the total count mode is executed. In the collation mode, the reading control section 36 counts the number of documents M1 without reference to the target condition. In the collation mode, the reading control section 36 checks whether the total number of documents M1 counted this time matches the total number of documents M1 counted in the total count mode. In the collation mode, the reading control section 36 notifies the user whether the total number of documents M1 counted this time matches the total number of documents M1 counted in the total count mode. For example, when the total number of documents M1 counted this time does not coincide with the total number of documents M1 counted in the total count mode, the reading control section 36 causes the reading display section 35 or the terminal display section 15 to display to that effect. That is, the reading control section 36 causes the reading display section 35 or the terminal display section 15 to display that the total number of documents M1 counted this time does not match the total number of documents M1 counted in the total count mode. In the collation mode, the user can recognize when an unintended document M1 is mixed into the document bundle MA, or when a document M1 is missing from the document bundle MA.

### Screens

Next, screens displayed on the display section will be described. The screens described below may be displayed on the terminal display section 15 by the terminal control section 16, or may be displayed on the reading display section 35 by the reading control section 36.

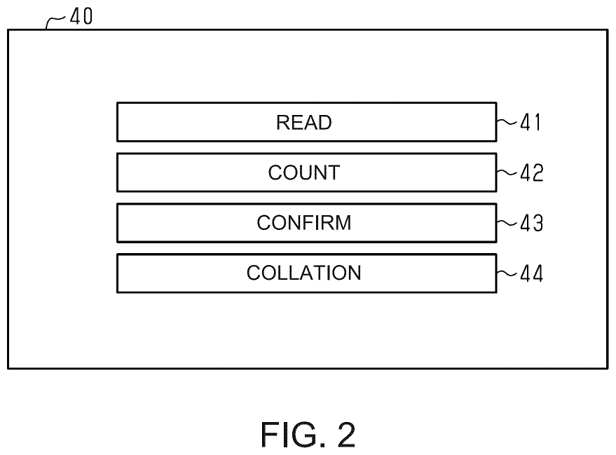

As shown in FIG. 2, a plurality of buttons are displayed on a home screen 40. In one example, on the home screen 40, a read button 41, a count button 42, a confirm button 43, a collation button 44, and the like are displayed. The read button 41 is a button for starting reading of a document M1. The count button 42 is a button for starting the count mode or the total count mode. The confirm button 43 is a button for starting the confirmation mode. The collation button 44 is a button for starting the collation mode. The user operates the buttons to cause the image reading device 13 to read the document M1, to execute the count mode, and the like.

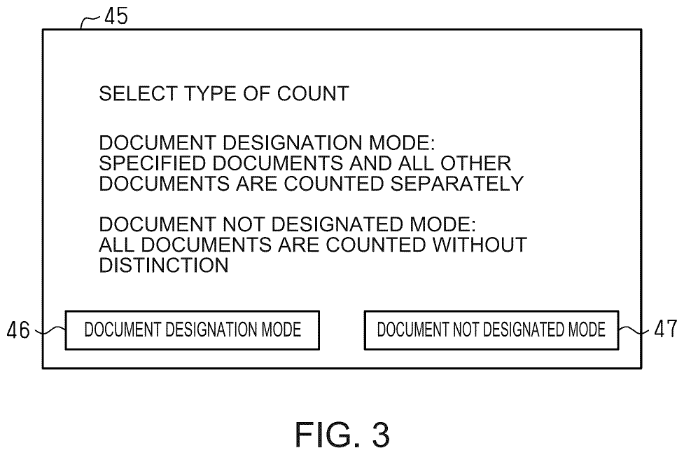

As shown in FIG. 3, when the count button 42 is operated on the home screen 40, a selection screen 45 is displayed. The selection screen 45 is a screen for selecting the count mode or the total count mode.

A plurality of buttons are displayed on the selection screen 45. In one example, on the selection screen 45, a designation button 46 and a no designation button 47 are displayed. The designation button 46 is a button for specifying the documents M1 that are to be the target of counting. The designation button 46 is operated to count specified documents M1. The designation button 46 is operated to set a target condition. When the designation button 46 is operated, the count mode is started. The no designation button 47 is a button for not specifying the documents M1 that are to be the target of counting. The no designation button 47 is operated to count all the document M1. The no designation button 47 is operated when no target condition is set. When the no designation button 47 is operated, the total count mode is started. The selection screen 45 may display a message prompting that either the designation button 46 or the no designation button 47 is to be operated.

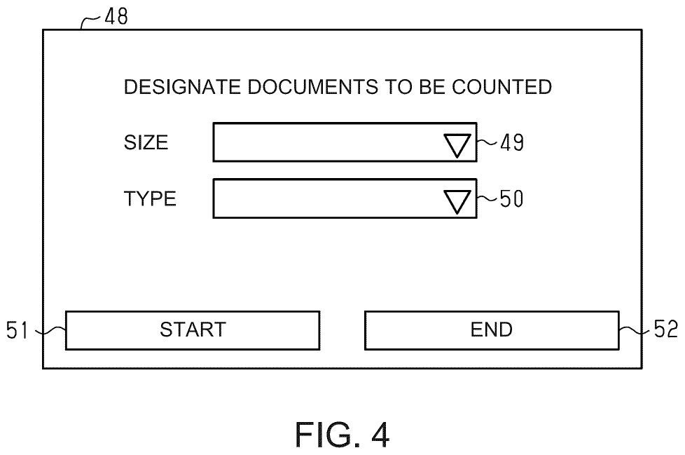

As shown in FIG. 4, when the designation button 46 is operated on the selection screen 45, a setting screen is displayed. More specifically, a count setting screen 48 is displayed. The setting screen is a screen for setting the target condition. The count setting screen 48 is a screen for setting the condition of the document M1 for the count mode.

One or more buttons are displayed on the count setting screen 48. On the count setting screen 48, at least one of a size designation button 49 and a type designation button 50 is displayed. The count setting screen 48 may display only the size designation button 49, only the type designation button 50, or both buttons. In one example, both the size designation button 49 and the type designation button 50 are displayed on the count setting screen 48.

The size designation button 49 is a button for designating the size of document M1. When the size designation button 49 is operated, A5, A4, A3, B5, B4, and the like are displayed in a pull-down menu. The type designation button 50 is a button for specifying the type of document M1. When the type designation button 50 is operated, plain paper, high quality paper, recycled paper, thick paper, and the like are displayed in a pull-down menu.

On the count setting screen 48, a start button 51 is displayed. When the start button 51 is operated, counting of documents M1 is started. When the start button 51 is operated, the documents M1 are counted based on the target condition set using the size designation button 49 and the type designation button 50.

On the count setting screen 48, an end button 52 is displayed. When the end button 52 is operated, the count mode is stopped. When the end button 52 is operated, the home screen 40 is displayed.

Multiple target conditions may be settable in the count setting screen 48 For example, a target condition that the size is A4 and the type is plain paper and a target condition that the size is A5 and the type is recycled paper may be set. In this case, the reading control section 36 separately counts the documents M1 that meet the respective target conditions.

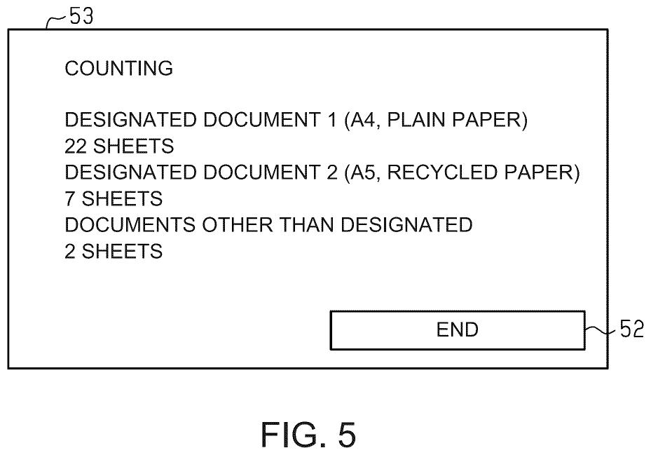

As shown in FIG. 5, a status screen 53 may be displayed during the count mode. The status screen 53 is a screen for displaying the current number of document sheets that have been counted. The current number of sheets of documents M1 that match the target conditions is displayed on the status screen 53. For example, the current number of A4 size plain paper type sheets of documents M1 and the current number of A5 size recycled paper type sheets of documents M1 are displayed on the status screen 53. In one example, the status screen 53 also displays the current number of sheets of documents M1 that do not meet the target condition. The status screen 53 may display information indicating how many sheets of the documents M1 that do not match the target condition were read from when count of the documents M1 was started.

The status screen 53 may display an end button 52. When the end button 52 is operated, the count mode is stopped. By this, the user can exit the count mode immediately. When the end button 52 is operated, the home screen 40 is displayed. The count mode may be temporarily interrupted by operating the end button 52.

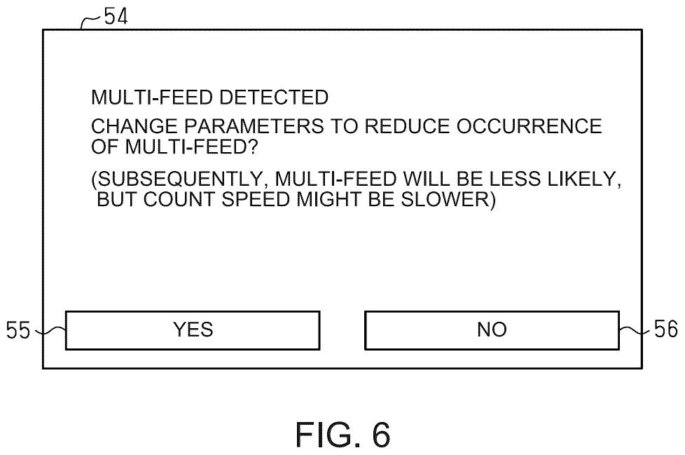

As shown in FIG. 6, when the multi-feed is detected during the count mode, a change screen is displayed. More specifically, when the multi-feed detection section 32 detects a multi-feed in the count mode, a count change screen 54 is displayed. A change screen is a screen for inquiring about a parameter change of transport section 23. The count change screen 54 is a screen for inquiring about a parameter change of the transport section 23 with respect to the count mode.

On the count change screen 54, a message is displayed asking the user whether to change the parameter of the transport section 23 in order to reduce the occurrence of multi-feeds. The count change screen 54 may display a message informing the user that the process speed will slow down if the parameter of the transport section 23 is changed. The count change screen 54 displays a YES button 55 and a NO button 56. When the YES button 55 is operated, the parameter of the transport section 23 is changed. More specifically, the reading control section 36 reduces the initial speed of the pick-up roller 24. For example, the reading control section 36 reduces the rotation speed immediately after the start of rotation of the pick-up roller 24. When the NO button 56 is operated, the parameter of the transport section 23 is not changed.

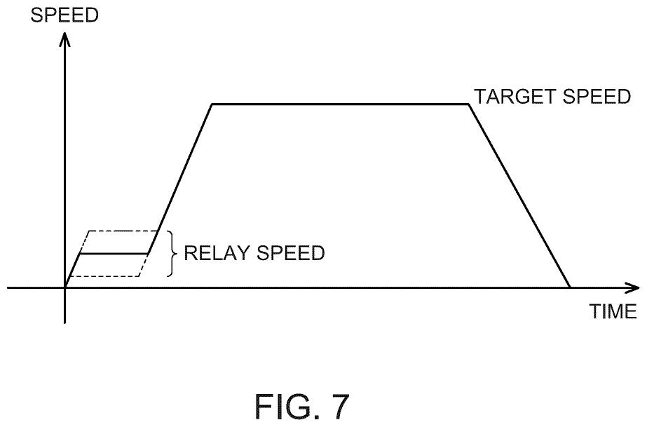

As shown in FIG. 7, the initial speed of the pick-up roller 24 may be reduced. For example, if the YES button 55 was operated on the count change screen 54, the relay speed of the pick-up roller 24 may be reduced. In this example, when the document M1 is fed, the rotation speed of the pick-up roller 24 changes so as to reach the target speed via the relay speed. After rotating at the relay speed for a predetermined time, the pick-up roller 24 accelerates to reach the target speed.

In FIG. 7, solid line indicates rotation speed of the pick-up roller 24 in the count mode. Broken line indicates rotation speed of the pick-up roller 24 after the parameter change. When the YES button 55 is operated on the count change screen 54, the relay speed is reduced. For example, when the YES button 55 is operated on the count change screen 54, the relay speed changes from the speed indicated in solid line to the speed indicated in broken line.

In FIG. 7, two-dot chain line indicates the rotation speed of the pick-up roller 24 when the document M1 is read. The rotation speed of the pick-up roller 24 in the count mode is less than the rotation speed of the pick-up roller 24 when the document M1 is read. By this, the counting accuracy is improved.

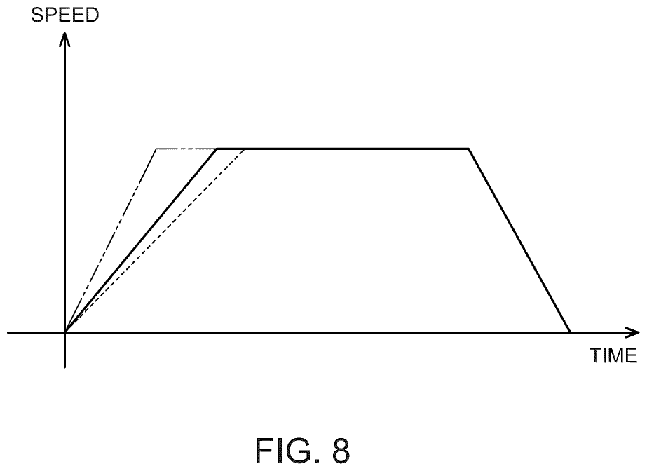

As shown in FIG. 8, the initial speed of the pick-up roller 24 may be reduced. For example, when the YES button 55 was operated on the count change screen 54, the acceleration of the pick-up roller 24 may be reduced. In this example, the pick-up roller 24 accelerates at a predetermined acceleration toward the target speed.

In FIG. 8, solid line indicates rotation speed of the pick-up roller 24 in the count mode. Broken line indicates rotation speed of the pick-up roller 24 after the parameter change. Two-dot chain line indicates rotation speed of the pick-up roller 24 when the document M1 is read. When the YES button 55 is operated on the count change screen 54, the acceleration decreases. For example, when the YES button 55 is operated on the count change screen 54, the acceleration is changed from the speed indicated by solid line to the speed indicated by broken line.

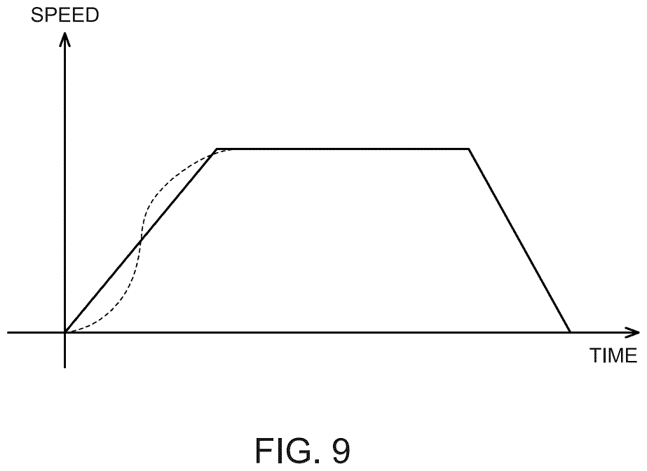

As shown in FIG. 9, the initial speed of the pick-up roller 24 may be reduced. For example, if the YES button 55 was operated on the count change screen 54, the acceleration curve may be changed so as to decrease the initial speed of the pick-up roller 24. In this example, the pick-up roller 24 accelerates at a predetermined acceleration toward the target speed.

In FIG. 9, solid line indicates the rotation speed of the pick-up roller 24 in the count mode. Broken line indicates rotation speed of the pick-up roller 24 after the parameter change. When the YES button 55 is operated on the count change screen 54, the acceleration curve changes. For example, when the YES button 55 is operated on the count change screen 54, the solid line acceleration curve changes to the broken line. In one example, the pick-up roller 24 accelerates so that the acceleration curve is recessed downward in the first half of the acceleration section, and accelerates so that the acceleration curve protrudes upward in the second half of the acceleration section.

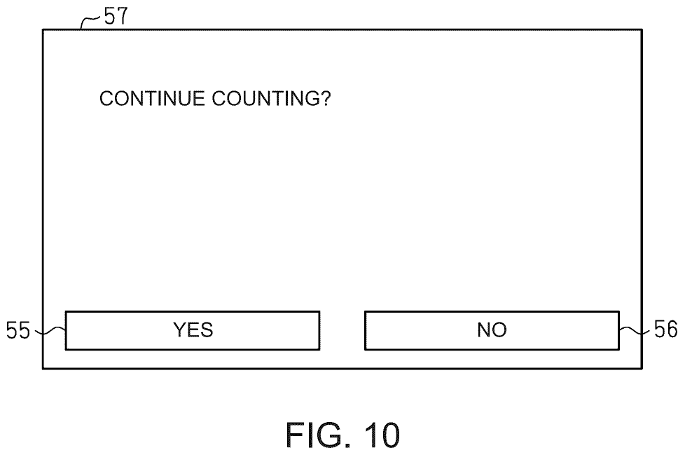

As shown in FIG. 10, when the YES button 55 or the NO button 56 is operated on the count change screen 54, a continuation screen is displayed. More specifically, a count continue screen 57 is displayed. That is, when the multi-feed detection section 32 detects a multi-feed in the count mode, the count continue screen 57 is displayed. The continuation screen is a screen for asking the user whether to continue the mode. The count continue screen 57 is a screen for asking the user whether to continue the count mode. If a multi-feed was detected, the documents M1 may not be counted correctly. Therefore, the continuation screen is displayed.

On the count continue screen 57, a message is displayed asking the user whether to continue counting. On the count continue screen 57, a YES button 55 and a NO button 56 are displayed. When the YES button 55 is operated, the count mode is continued. In one example, when the YES button 55 is operated, the status screen 53 is displayed. When the NO button 56 is operated, the count mode is ended. In one example, when the NO button 56 is operated, the home screen 40 is displayed.

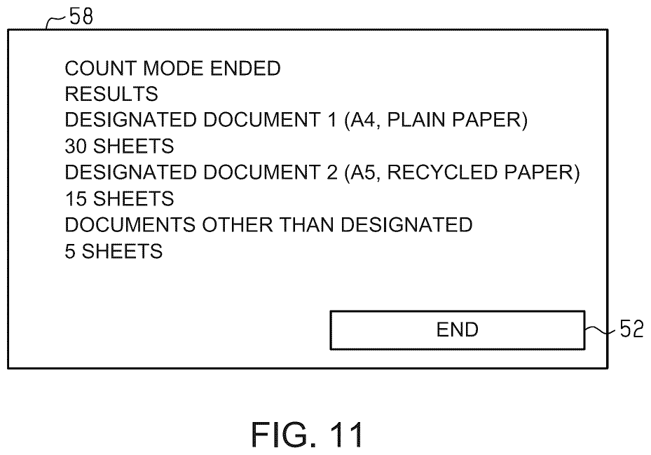

As shown in FIG. 11, when all the documents M1 have been transported, an end screen is displayed. More specifically, after the last document M1 is transported in the count mode, a count end screen 58 is displayed. The end screen is a screen displayed at the end of a mode. The count end screen 58 is a screen for the end of the count mode.

The results of having executed the mode are displayed on the end screen. The numbers of counted sheets of document M1 are displayed on the count end screen 58. That is, the count end screen 58 displays the number of sheets of documents M1 that match the target condition. For example, the count end screen 58 displays the number of sheets of documents M1 that are size A4 and that are plain paper type and the number of sheets of documents M1 that are size A5 and that are recycled paper type. In one example, the count end screen 58 also displays the number of sheets of documents M1 that do not meet a target condition. By visually checking the count end screen 58, the user understands that documents M1 that are not reading targets are included in the document bundle MA. The status screen 53 may display information indicating how many sheets of the documents M1 that do not match the target condition were read from when count of the documents M1 was started.

On the count end screen 58, the end button 52 is displayed. When the end button 52 is operated, the count end screen 58 closes. After confirming the count result, the user operates the end button 52.

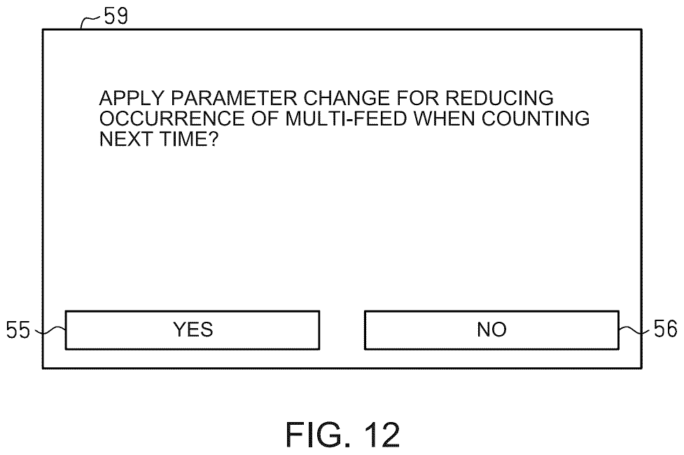

As shown in FIG. 12, when the end button 52 is operated on the count end screen 58, a preserve screen may be displayed. More specifically, a count preserve screen 59 may be displayed at the end of the count mode in which a parameter change of the transport section 23 was permitted in the count change screen 54. In one example, if a parameter change of the transport section 23 was permitted through the count change screen 54, the count preserve screen 59 is displayed after the last document M1 is transported in the count mode. The preserve screen is a screen for asking the user whether the parameter change of the transport section 23 should be maintained in the mode next time. The count preserve screen 59 is a screen for asking the user whether the parameter change of the transport section 23 should be maintained in the count mode next time.

The count preserve screen 59 displays a message asking the user whether to maintain the parameter change of the transport section 23. A YES button 55 and a NO button 56 are displayed on the count preserve screen 59. When the YES button 55 is operated, the parameter change of the transport section 23 is maintained. That is, the next time that count mode is performed, the pick-up roller 24 will be rotated in a state where the initial speed is small. When a multi-feed is detected the next time the count mode is performed, the parameter of the transport section 23 may be changed so that the initial speed of the pick-up roller 24 is further reduced. When the NO button 56 is operated, the parameter change of the transport section 23 is not maintained. The next time that the count mode is performed, the pick-up roller 24 will rotate at a normal initial speed.

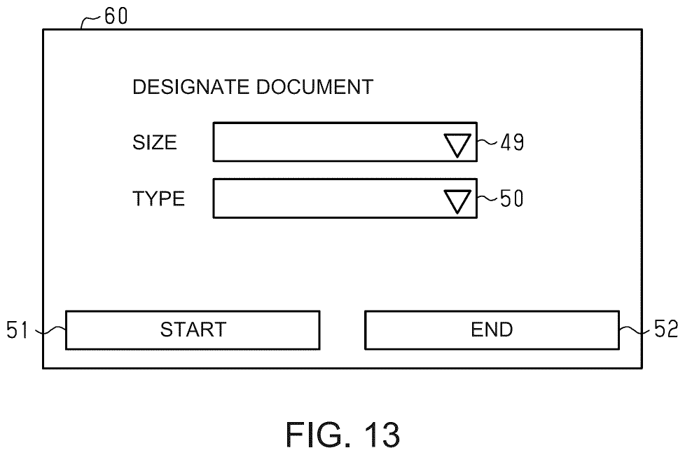

As shown in FIG. 13, when the confirm button 43 is operated on the home screen 40, a setting screen is displayed. More specifically, a confirmation setting screen 60 is displayed. The confirmation setting screen 60 is a screen for setting the conditions of the document M1 in the confirmation mode.

The confirmation setting screen 60 is a screen similar to the count setting screen 48. On the confirmation setting screen 60, one or more buttons are displayed. On the confirmation setting screen 60, at least one of the size designation button 49 or the type designation button 50 is displayed. In one example, both the size designation button 49 and the type designation button 50 are displayed on the confirmation setting screen 60.

On the confirmation setting screen 60, the start button 51 is displayed. When the start button 51 is operated, confirmation of the document M1 begins. When the start button 51 is operated, the documents M1 are confirmed based on the target condition set by the size designation button 49 and the type designation button 50.

On the confirmation setting screen 60, the end button 52 is displayed. When the end button 52 is operated, the confirmation mode is ended. When the end button 52 is operated, the home screen 40 is displayed.

In the confirmation setting screen 60, multiple target conditions may be settable. For example, a target condition that the size is A4 and the type is plain paper and a target condition that the size is A5 and the type is recycled paper may be set.

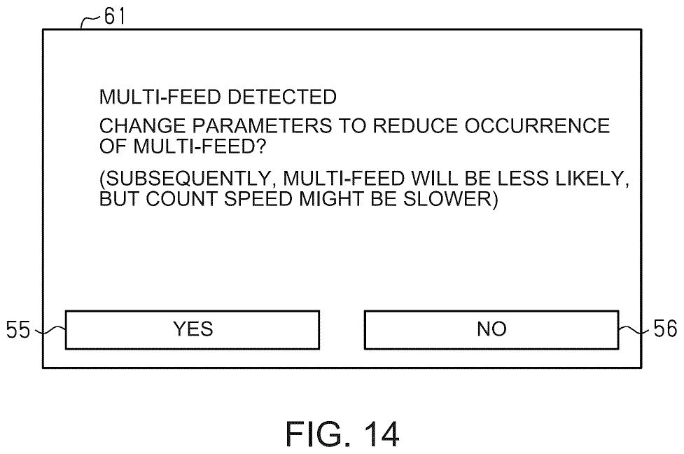

As shown in FIG. 14, when a multi-feed is detected during the confirmation mode, change screen is displayed. More specifically, when the multi-feed detection section 32 detects a multi-feed in the confirmation mode, a confirmation change screen 61 is displayed. The confirmation change screen 61 is a screen for inquiring about a parameter change of the transport section 23 in the confirmation mode.

The confirmation change screen 61 is a screen similar to the count change screen 54. On the confirmation change screen 61, a message is displayed, asking the user whether to change the parameter of the transport section 23 in order to reduce the occurrence of the multi-feed. The confirmation change screen 61 may display a message informing the user that the process speed will slow down if the parameter of the transport section 23 is changed. On the confirmation change screen 61, a YES button 55 and a NO button 56 are displayed. When the YES button 55 is operated, the parameter of the transport section 23 is changed. More specifically, the reading control section 36 reduces the initial speed of the pick-up roller 24. For example, as shown in the graphs of FIGS. 7, 8, and 9, the reading control section 36 reduces the rotation speed of the pick-up roller 24. When the NO button 56 is operated, the parameter of the transport section 23 is not changed.

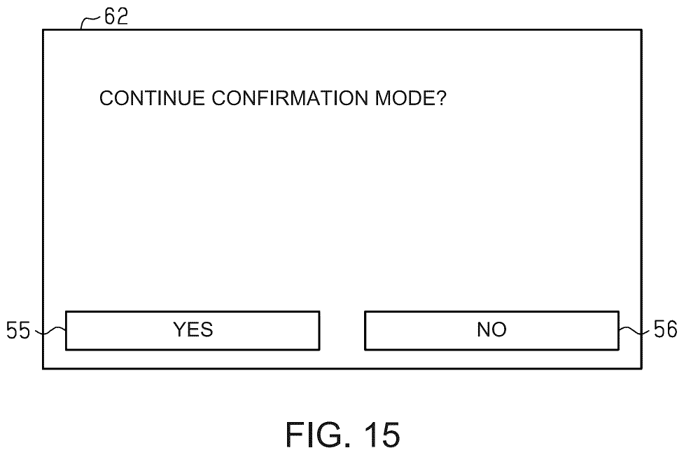

As shown in FIG. 15, when the YES button 55 or the NO button 56 is operated in the confirmation change screen 61, a continuation screen is displayed. More specifically, a confirmation continue screen 62 is displayed. That is, the confirmation continue screen 62 is displayed when the multi-feed detection section 32 detects a multi-feed in the confirmation mode. The confirmation continue screen 62 is a screen for asking the user whether to continue the confirmation mode.

The confirmation continue screen 62 is a screen similar to the count continue screen 57. The confirmation continue screen 62 displays a message inquiring whether the user wishes to continue counting. On the confirmation continue screen 62, a YES button 55 and a NO button 56 are displayed. When the YES button 55 is operated, the confirmation mode is continued. When the NO button 56 is operated, the confirmation mode is ended. In one example, when the NO button 56 is operated, the home screen 40 is displayed.

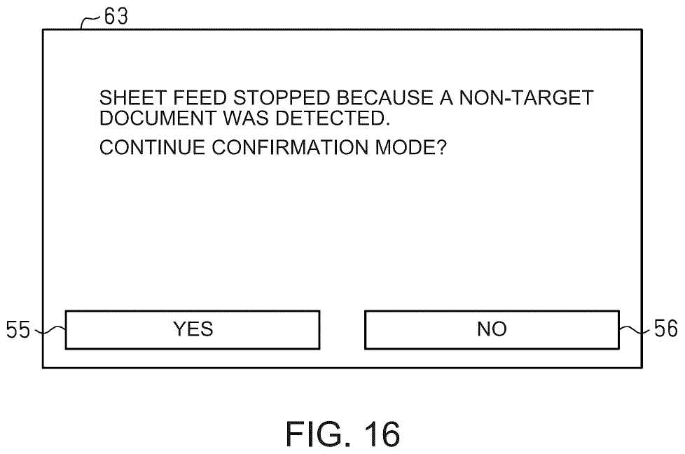

As shown in FIG. 16, when a document M1 that does not match the target condition is detected during the confirmation mode, a notification screen 63 is displayed. More specifically, when the detection section 27 detects a document M1 that does not match the target condition in the confirmation mode, the notification screen 63 is displayed. The notification screen 63 is a screen for notifying that a document M1 that does not match the target condition was detected. On the notification screen 63, a message is displayed notifying that a document M1 that does not match the target condition was detected.

The notification screen 63 is displayed after the transport section 23 is stopped when the detection section 27 detects the document M1 that does not match the target condition. By this, the possibility that a document M1 is unnecessarily transported is reduced.

The notification screen 63 is also a screen for asking the user whether to continue the confirmation mode. The notification screen 63 displays a message asking the user whether to continue the confirmation mode. On the notification screen 63, a YES button 55 and a NO button 56 are displayed. When the YES button 55 is operated, the confirmation mode is continued. When the NO button 56 is operated, the confirmation mode is ended. In one example, when the NO button 56 is operated, the home screen 40 is displayed.

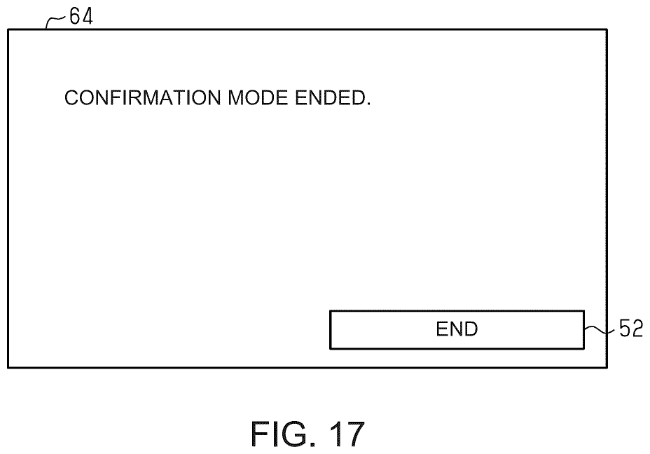

As shown in FIG. 17, when all the documents M1 have been transported, an end screen is displayed. More specifically, a confirmation end screen 64 is displayed after the last document M1 is transported in the confirmation mode. The confirmation end screen 64 is a screen for ending the confirmation mode. The end button 52 is displayed on the confirmation end screen 64. When the end button 52 is operated, the confirmation end screen 64 closes.

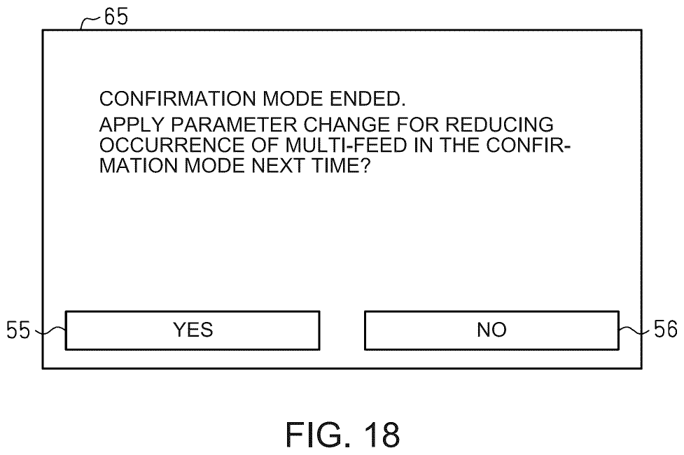

As shown in FIG. 18, a preserve screen may be displayed when all the documents M1 have been transported. More specifically, a confirmation preserve screen 65 may be displayed at the end of the confirmation mode in which a parameter change of the transport section 23 was permitted in the confirmation change screen 61. In one example, when a parameter change of the transport section 23 was permitted through the confirmation change screen 61, the confirmation preserve screen 65 is displayed after the last document M1 is transported in the confirmation mode. The confirmation preserve screen 65 may be displayed instead of the confirmation end screen 64 or may be displayed after the confirmation end screen 64.

The confirmation preserve screen 65 is a screen similar to the count preserve screen 59. The confirmation preserve screen 65 displays a message inquiring whether to maintain the parameter change of the transport section 23. A YES button 55 and a NO button 56 are displayed on the confirmation preserve screen 65. When the YES button 55 is operated, the parameter change of the transport section 23 is maintained. That is, in the confirmation mode next time, the pick-up roller 24 will rotate in a state where the initial speed is small. When a multi-feed is detected in the confirmation mode next time, the parameter of the transport section 23 may be changed so that the initial speed of the pick-up roller 24 is further reduced. When the NO button 56 is operated, the parameter change of the transport section 23 is not maintained. In the confirmation mode next time, the pick-up roller 24 will rotate at the normal initial speed.

### Flowchart

Next, the operation of the image reading system 11 will be described. The operation in the count mode and the operation in the confirmation mode will be described in detail. The count mode and the confirmation mode may be executed only by the reading control section 36, or may be executed by both the reading control section 36 and the terminal control section 16. Here, the reading control section 36 and the terminal control section 16 will simply be referred to as the control section, without distinguishing one from the other.

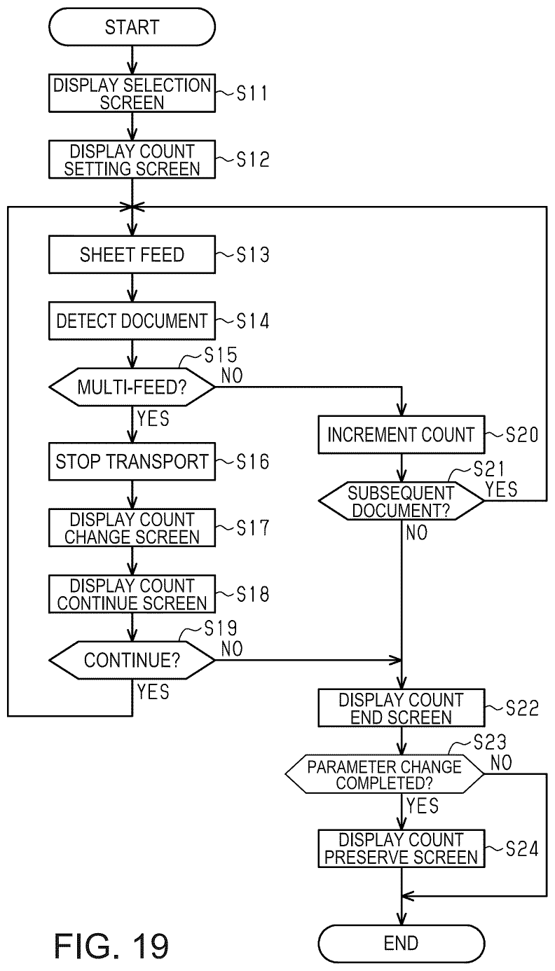

First, the operation in the count mode will be described with reference to FIG. 19. A similar operation may be performed in the total count mode. The flowchart shown in FIG. 19 is initiated when the count button 42 is operated on the home screen 40.

As shown in FIG. 19, the control section displays the selection screen 45 in step S11. The user selects the count mode or the total count mode on selection screen 45.

In step S12, the control section displays the count setting screen 48. The user sets a target condition in the count setting screen 48.

In step S13, the control section perform sheet feed of a document M1. More specifically, when the start button 51 is operated on the count setting screen 48, the control section performs sheet feed of the document M1. At this time, the control section starts the pick-up roller 24. In the total count mode, step S12 is skipped. In the total count mode, the process may be shifted to step S13 after the no designation button 47 is operated on the selection screen 45.

In step S14, the control section detects the document M1. Specifically, the control section detects the document M1 using the detection section 27 and the multi-feed detection section 32.

In step S15, the control section judges whether or not a multi-feed has occurred. At this time, the control section judges whether the multi-feed detection section 32 has detected a multi-feed. If the multi-feed detection section 32 has not detected a multi-feed, the control section proceeds to step S20. When the multi-feed detection section 32 detects a multi-feed, the control section shifts the process to step S16.

In step S16, the control section stops transport of the document M1. At this time, the control section stops the transport section 23.

In step S17, the control section displays the count change screen 54. The user selects whether or not the parameter change of the transport section 23 is permitted. The control section changes the parameter of the transport section 23 when a parameter change was permitted by the user. When a parameter change is not permitted by the user, the parameter of the transport section 23 is not changed.

In step S18, the control section displays the count continue screen 57. The user selects whether or not to continue the count mode.

In step S19, the control section determines whether to continue the count mode. More specifically, the control section determines whether the YES button 55 or the NO button 56 was operated on the count continue screen 57. When the YES button 55 was operated, the control section returns the process to step S13. When the NO button 56 was operated, the control section shifts the process to step S22.

In step S20, the control section increments the count of the documents M1. More specifically, the control section determines whether the detected document M1 matches the target condition, and then increments the count for the documents M1. In the count mode, the control section increments the count based on the target condition. In one example, the control section separately counts the documents M1 that match the target condition and the documents M1 that do not match the target condition. In the total count mode, the control section increments the document M1 count without reference to the target condition.

In step S21, the control section determines whether there is a subsequent document M1. At this time, the control section determines the presence or absence of a document M1 based on whether the tray detection section 33 detects a document M1. When there is a document M1 on the supply tray 22, the control section returns the process to step S13. When there is no document M1 on the supply tray 22, the control section shifts the process to step S22.

In step S22, the control section displays the count end screen 58.

In step S23, the control section judges whether the parameter of the transport section 23 was changed. More specifically, the control section judges whether a parameter change of the transport section 23 was permitted in step S17. When a parameter change of the transport section 23 was permitted, the control section shifts the process to step S24. When a parameter change of the transport section 23 was not permitted, the control section ends the count mode.

In step S24, the control section displays the count preserve screen 59. When the YES button 55 or the NO button 56 is operated on the count preserve screen 59, the control section ends the count mode. The parameter change may be reflected in the total count mode next time when the YES button 55 is operated in the total count mode.

If the selection screen 45, the count setting screen 48, the count change screen 54, the count continue screen 57, the count end screen 58, the count preserve screen 59, and the like are not displayed during the count mode, then the control section may display the status screen 53.

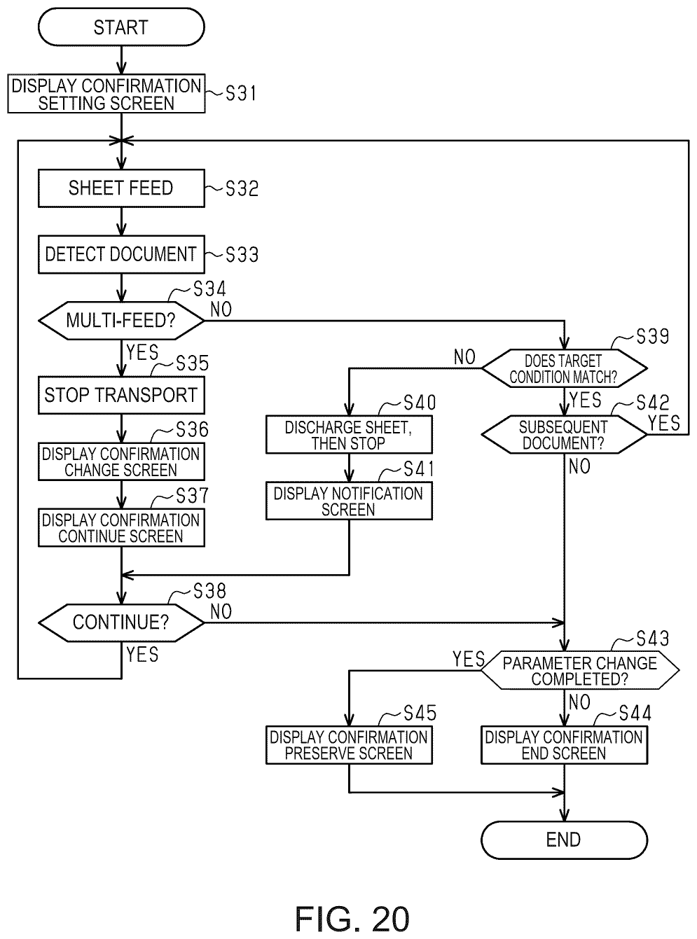

Next, the operation in the confirmation mode will be described with reference to FIG. 20. The flowchart shown in FIG. 20 is initiated when the confirm button 43 is operated on the home screen 40.

As shown in FIG. 20, the control section displays the confirmation setting screen 60 at step S31. The user sets the target condition in the confirmation setting screen 60.

In step S32, the control section performs sheet feed of a document M1. More specifically, the control section feeds the document M1 when the start button 51 is operated on the confirmation setting screen 60. At this time, the control section starts the pick-up roller 24.

In step S33, the control section detects document M1. Specifically, the control section detects the document M1 using the detection section 27 and the multi-feed detection section 32.

In step S34, the control section judges whether or not a multi-feed has occurred. At this time, the control section judges whether the multi-feed detection section 32 has detected a multi-feed. If the multi-feed detection section 32 does not detect a multi-feed, the control section shifts the process to step S39. When the multi-feed detection section 32 detects a multi-feed, the control section shifts the process to step S35.

In step S35, the control section stops transport of the document M1. At this time, the control section stops the transport section 23.

In step S36, the control section displays the confirmation change screen 61. The user selects whether or not the parameter change of the transport section 23 is permitted. The control section changes the parameter of the transport section 23 when a parameter change was permitted by the user. When a parameter change is not permitted by the user, the parameter of the transport section 23 is not changed.

In step S37, the control section displays the confirmation continue screen 62. The user selects whether or not to continue the confirmation mode.

In step S38, the control section determines whether to continue the confirmation mode. For example, the control section determines whether the YES button 55 or the NO button 56 is operated on the confirmation continue screen 62. When the YES button 55 is operated, the control section returns the process to step S32. When the NO button 56 is operated, the control section shifts the process to step S43.

In step S39, the control section determines whether the detected document M1 matches the target condition. When the target condition is met, the control section shifts the process to step S42. When the target condition is not met, the control section shifts the process to step S40.

In step S40, the control section causes the document M1 to be discharged. After the document M1 is discharged, the control section stops the transport section 23.

In step S41, the control section displays the notification screen 63. After the notification screen 63 is displayed, the control section proceeds to step S38. In step S38, the control section determines whether the YES button 55 was operated or the NO button 56 was operated on the notification screen 63.

In step S42, the control section determines whether a subsequent document M1 is present. At this time, the control section determines the presence or absence of a document M1 based on whether the tray detection section 33 detects a document M1. If there is document M1 on supply tray 22, the control section returns the process to step S32. When there is no document M1 on the supply tray 22, the control section shifts the process to step S43.

In step S43, the control section judges whether the parameter of the transport section 23 was changed. More specifically, the control section judges whether or not the parameter change of the transport section 23 was permitted in step S36. When a parameter change of the transport section 23 was permitted, the control section shifts the process to step S45. When a parameter change of the transport section 23 was not permitted, the control section shifts the process to step S44.

In step S44, the control section displays the confirmation end screen 64. When the end button 52 is operated on the confirmation end screen 64, the control section ends the confirmation mode.

In step S45, the control section displays the confirmation preserve screen 65. When the YES button 55 or the NO button 56 is operated on the confirmation preserve screen 65, the control section ends the confirmation mode.

As described above, the control method of the image reading system 11 includes the detection section 27 detecting the document M1 and the display section displaying that a document M1 that does not match the target condition was detected if a document M1 that does not match the target condition was detected.

### Operations and Effects of Embodiment

Next, the operations and effects of the above-described embodiment will be explained.

(1) When the detection section 27 detects a document M1 that does not match the target condition that was set through the setting screen, the control section causes the display section to display that a document M1 that does not match the target condition was detected. According to the above configuration, the display section indicates that a document M1 that does not meet the target condition was detected, allowing the user to understand that an unintended document M1 was mixed into the document bundle MA. By removing that document M1, the user can obtain a document bundle MA in which documents M1 that meet the target condition are stacked. The user can obtain the desired reading result by having that document bundle MA read.

(2) In the count mode, the control section causes the display section to display the number of sheets of documents M1 that match the target condition. According to the above configuration, the user can grasp the number of sheets of documents M1 to be read.

(3) On the count setting screen 48, at least one of the size designation button 49 or the type designation button 50 is displayed along with the start button 51. According to the above configuration, the user can operate the setting of the target condition and the start of the count mode on the count setting screen 48. Therefore, the usability is improved.

(4) In the count mode, the control section displays the count change screen 54 when the multi-feed detection section 32 detects a multi-feed. According to the above configuration, since the parameter of the transport section 23 is changed, a multi-feed is less likely to occur.

(5) In the count mode, the control section displays a count continue screen 57 when the multi-feed detection section 32 detects a multi-feed. When a multi-feed occurs, the documents M1 are not correctly counted. According to the above configuration, when a multi-feed occurs, the count mode can be immediately stopped.

(6) After the last document M1 is transported in the count mode, the control section displays a count end screen 58 on the display section. The count end screen 58 displays the number of sheets of documents M1 that match the target condition and the number of sheets of documents M1 that do not match the target condition. According to the above configuration, the user can grasp the number of sheets of documents M1 to be read and the number of sheets of documents M1 that are not the target of reading.

(7) When a parameter change of the transport section 23 was permitted through the count change screen 54, the control section displays the count preserve screen 59 after the last document M1 is transported in the count mode. According to the above configuration, it is possible to reduce the risk of occurrence of multi-feed in the count mode next time.

(8) The control section displays the status screen 53 in the count mode. According to the above configuration, the user can grasp the current number of document sheets that are the target of reading.

(9) In the confirmation mode, the control section causes the notification screen 63 to be displayed when detection section 27 detects a document M1 that does not match the target condition. According to the above configuration, the user can recognize that a document M1 that is not a reading target is included in the document bundle MA.

(10) The control section causes display of the confirmation change screen 61 when the multi-feed detection section 32 detects a multi-feed in the confirmation mode. According to the above configuration, since the parameter of the transport section 23 is changed, a multi-feed is less likely to occur.

(11) The control section causes display of the confirmation continue screen 62 when the multi-feed detection section 32 detects a multi-feed in the confirmation mode. When a multi-feed occurs, the documents M1 are not correctly confirmed. According to the above configuration, when a multi-feed occurs, the confirmation mode can be immediately stopped.

(12) When the detection section 27 detects a document M1 that does not match the target condition in the confirmation mode, the control section displays the notification screen 63 after stopping the transport section 23. According to the above configuration, the risk that a document M1 will be unnecessarily transported is reduced.

(13) When a parameter change of the transport section 23 was permitted through the confirmation change screen 61, the control section displays the confirmation preserve screen 65 after the last document M1 is transported in the confirmation mode. According to the above configuration, it is possible to reduce the risk of occurrence of a multi-feed in the confirmation mode next time.

(14) The control section displays the confirmation end screen 64 after the last document M1 is transported in the confirmation mode. According to the above configuration, the user can recognize that the confirmation mode has ended.

(15) In the total count mode, the control section causes the display section to display the number of sheets of documents M1 that have been counted. According to the above configuration, the user can grasp the total number of documents M1.

(16) In the collation mode, when the total number of counted documents M1 does not coincide with the total number of documents M1 that were counted in the total count mode, the control section causes the display section to display that the total number of counted documents M1 does not coincide with the total number of document M1 that were counted in the total count mode. According to the above configuration, the user can recognize that the numbers of sheets of documents M1 do not match.

### Technical Gist

In the following, the technical gist and the operations and effects obtained from the above-mentioned embodiment and modifications will be described.

(A) The image reading system includes a transport section for transporting sheets of documents one sheet at a time from a document bundle; a reading section for reading a document; a detection section for detecting a document; a display section for displaying a setting screen on which a document condition is set as a target condition of a document that is a reading target; and a control section, wherein when the detection section detects a document that does not meet the target condition, the control section causes the display section to display that a document that does not meet the target condition has been detected. According to the above configuration, the display section indicates that a document not matching the target condition has been detected, allowing the user to recognize that an unintended document is mixed in the document bundle. By removing that document, the user can obtain a document bundle in which documents that meet the target condition are stacked. The user can obtain the desired reading result by having the document bundle read.

(B) The image reading system may be such that in a count mode for counting documents matching the target condition, the control section causes the display section to display the number of sheets of documents matching the target condition. According to the above configuration, the user can grasp the number of sheets of documents to be read.

(C) The image reading system may be such that the detection section is configured to detect at least one of a size of the document and a type of the document and in the setting screen are displayed at least one of a size designation button for designating a size of a document and a type designation button for designating a type of the document and a start button for starting the count mode. According to the above configuration, the user can operate the setting of the target condition and the start of the count mode on the setting screen. Therefore, the usability is improved.

(D) The image reading system includes a multi-feed detection section for detecting multi-feed of documents, wherein when the multi-feed detection section detects a multi-feed in the count mode, the control section displays a change screen for inquiring about a parameter change of the transport section. According to the above-described configuration, since the parameters of the transport section are changed, a multi-feed is less likely to occur.

(E) The image reading system may be such that when the multi-feed detection section detects a multi-feed in the count mode, the control section displays a continuation screen inquiring about continuing the count mode. When a multi-feed occurs, the documents are not counted correctly. According to the above configuration, when a multi-feed occurs, the count mode can be immediately stopped.

(F) The image reading system may be such that after the last document is transported in the count mode, the control section displays an end screen for ending the count mode and the number of sheets of documents that meet the target condition and the number of sheets of documents that do not meet the target condition are displayed on the end screen. According to the above configuration, the user can grasp the number of document sheets that are reading targets and the number of document sheets that are not reading targets.

(G) The image reading system may be such that when a parameter change of the transport section was permitted through the change screen, then after the last document is transported in the count mode, the control section causes a preserve screen to be displayed to inquire whether to preserve the parameter of the transport section for the count mode next time. According to the above configuration, it is possible to reduce the risk of occurrence of multi-feed in the count mode next time.

(H) The image reading system may be such that in the count mode, the control section displays a status screen to show the current number of document sheets that have been counted. According to the above configuration, the user can grasp the current number of document sheets that are the target of reading.

(I) The image reading system may be such that in a confirmation mode for confirming the presence or absence of a document that does not match the target condition, the control section displays a notification screen for inquiring whether to end the confirmation mode when the detection section detects a document that does not match the target condition. According to the above configuration, the user can recognize that a document that is not a target of reading is included in the document bundle.

(J) The image reading system may further include a multi-feed detection section for detecting multi-feed of documents, wherein when the multi-feed detection section detects multi-feed in the confirmation mode, the control section displays a change screen inquiring about a parameter change of the transport section. According to the above-described configuration, since the parameters of the transport section are changed, a multi-feed is less likely to occur.

(K) The image reading system may be such that when the multi-feed detection section detects a multi-feed in the confirmation mode, the control section displays a continuation screen to inquire whether to continue the confirmation mode. If a multi-feed occurs, the documents are not checked correctly. According to the above configuration, when a multi-feed occurs, the confirmation mode can be immediately stopped.

(L) The image reading system may be such that when the detection section detects a document that does not match the target condition in the confirmation mode, the control section displays the notification screen after stopping the transport section. According to the above configuration, it is possible to reduce the possibility that a document will be unnecessarily transported.

(M) The image reading system may be such that when a parameter change of the transport section was permitted through the change screen, then after the last document is transported in the confirmation mode, the control section causes display of a preserve screen to inquire whether to preserve the parameter of the transport section for the confirmation mode next time. According to the above configuration, it is possible to reduce the risk of occurrence of a multi-feed in the confirmation mode next time.

(N) The image reading system may be such that after the last document is transported in the confirmation mode, the control section displays an end screen for ending the confirmation mode. According to the above configuration, the user can recognize that the confirmation mode has ended.

(O) The image reading system may be such that in a total count mode in which documents are counted without reference to the target condition, the control section causes the display section to display the number of sheets of documents that have been counted. According to the above configuration, the user can grasp the total number of documents.

(P) The image reading system may be such that in a collation mode in which the control section counts the number of sheets of documents without reference to the target condition and then collates the total number of sheets of documents that were counted this time with the total number of sheets documents that were counted in the total count mode, when there is a discrepancy between the total number of sheets of documents that were counted this time and the total number of sheets of documents that were counted in the total count mode, then the control section causes the display section to display that the total number of sheets of documents that were counted this time does not match the total number of sheets of documents that were counted in the total count mode. According to the above configuration, the user can recognize that the number of sheets of documents do not match.

(Q) The image reading device includes a transport section for transporting sheets of documents one sheet at a time from a document bundle; a reading section for reading a document; a detection section for detecting a document; a display section for displaying a setting screen on which a document condition is set as a target condition of a document that is a reading target; and a control section, wherein when the detection section detects a document that does not meet the target condition, the control section causes the display section to display that a document that does not meet the target condition has been detected. According to the above configuration, the same effects as those of the image reading system described above can be obtained.

(R) The control device is a control device connected to an image reading device, the image reading device including a transport section for transporting sheets of documents one sheet at a time from a document bundle; a reading section for reading a document; a detection section for detecting a document; the control device including a display section for displaying a setting screen on which a document condition is set as a target condition, which is a condition of a document that is the reading target of the image reading device and a control section configured to communicate with the image reading device, wherein when the detection section detects a document that does not meet the target condition, the control section causes the display section to display that a document that does not meet the target condition has been detected. According to the above configuration, the same effects as those of the image reading system described above can be obtained.

(S) The control method for an image reading system, the image reading system including a transport section for transporting sheets of documents one sheet at a time from a document bundle; a reading section for reading a document; a detection section for detecting a document; a display section for displaying a setting screen on which a document condition is set as a target condition of a document that is a reading target; and the control method including the detection section detecting a document and when a document that does not meet the target condition was detected, the display section indicating that a document not meeting the target condition was detected. According to the above method, the same effects as those of the image reading system described above can be obtained.

What is claimed is:

1. An image reading system comprising:
a transport section for transporting sheets of documents one sheet at a time from a document bundle;
a reading section for reading a document;
a detection section for detecting a document;
a display section for displaying a setting screen on which a document condition is set as a target condition of a document that is a reading target; and
a control section, wherein
when the detection section detects a document that does not meet the target condition, the control section causes the display section to display that a document that does not meet the target condition has been detected.

2. The image reading system according to claim 1, wherein
in a count mode for counting documents matching the target condition, the control section causes the display section to display the number of sheets of documents matching the target condition.

3. The image reading system according to claim 2, wherein
the detection section is configured to detect at least one of a size of the document and a type of the document and
in the setting screen are displayed
at least one of a size designation button for designating a size of a document and a type designation button for designating a type of the document and
a start button for starting the count mode.

4. The image reading system according to claim 2, further comprising:
a multi-feed detection section for detecting multi-feed of documents, wherein
when the multi-feed detection section detects a multi-feed in the count mode, the control section displays a change screen for inquiring about a parameter change of the transport section.

5. The image reading system according to claim 4, wherein
when the multi-feed detection section detects a multi-feed in the count mode, the control section displays a continuation screen inquiring about continuing the count mode.

6. The image reading system according to claim 2, wherein
after the last document is transported in the count mode, the control section displays an end screen for ending the count mode and
the number of sheets of documents that meet the target condition and the number of sheets of documents that do not meet the target condition are displayed on the end screen.

7. The image reading system according to claim 4, wherein
when a parameter change of the transport section was permitted through the change screen, then after the last document is transported in the count mode, the control section causes a preserve screen to be displayed to inquire whether to preserve the parameter of the transport section for the count mode next time.

8. The image reading system according to claim 2, wherein
in the count mode, the control section displays a status screen to show the current number of document sheets that have been counted.

9. The image reading system according to claim 1, wherein
in a confirmation mode for confirming the presence or absence of a document that does not match the target condition, the control section displays a notification screen for inquiring whether to end the confirmation mode when the detection section detects a document that does not match the target condition.

10. The image reading system according to claim 9, further comprising:
a multi-feed detection section for detecting multi-feed of documents, wherein
when the multi-feed detection section detects multi-feed in the confirmation mode, the control section displays a change screen inquiring about a parameter change of the transport section.

11. The image reading system according to claim 10, wherein
when the multi-feed detection section detects a multi-feed in the confirmation mode, the control section displays a continuation screen to inquire whether to continue the confirmation mode.

12. The image reading system according to claim 9, wherein
when the detection section detects a document that does not match the target condition in the confirmation mode, the control section displays the notification screen after stopping the transport section.

13. The image reading system according to claim 10, wherein
when a parameter change of the transport section was permitted through the change screen, then after the last document is transported in the confirmation mode, the control section causes display of a preserve screen to inquire whether to preserve the parameter of the transport section for the confirmation mode next time.

14. The image reading system according to claim 9, wherein
after the last document is transported in the confirmation mode, the control section displays an end screen for ending the confirmation mode.

15. The image reading system according to claim 1, wherein
in a total count mode in which documents are counted without reference to the target condition, the control section causes the display section to display the number of sheets of documents that have been counted.

16. The image reading system according to claim 15, wherein
in a collation mode in which the control section counts the number of sheets of documents without reference to the target condition and then collates the total number of sheets of documents that were counted this time with the total number of sheets documents that were counted in the total count mode, when there is a discrepancy between the total number of sheets of documents that were counted this time and the total number of sheets of documents that were counted in the total count mode, then the control section causes the display section to display that the total number of sheets of documents that were counted this time does not match the total number of sheets of documents that were counted in the total count mode.

17. An image reading device comprising:
a transport section for transporting sheets of documents one sheet at a time from a document bundle;
a reading section for reading a document;
a detection section for detecting a document;
a display section for displaying a setting screen on which a document condition is set as a target condition of a document that is a reading target; and
a control section, wherein
when the detection section detects a document that does not meet the target condition, the control section causes the display section to display that a document that does not meet the target condition has been detected.

18. A control device connected to an image reading device, the image reading device including a transport section for transporting sheets of documents one sheet at a time from a document bundle, a reading section for reading a document, and a detection section for detecting a document, the control device comprising:
a display section for displaying a setting screen on which a document condition is set as a target condition, which is a condition of a document that is the reading target of the image reading device and
a control section configured to communicate with the image reading device, wherein
when the detection section detects a document that does not meet the target condition, the control section causes the display section to display that a document that does not meet the target condition has been detected.
